(19) United States
(12) Patent Application Publication
(10) Pub. No.: US 2013/0325499 A1
(43) Pub. Date: Dec. 5, 2013

(54) HEALTH ACT TRANSACTIONS AND ANALYSIS SYSTEM

(71) Applicant: Children's Medical Center Corporation, Boston, MA (US)

(72) Inventor: Isaac S. Kohane, Newton, MA (US)

(21) Appl. No.: 13/910,906

(22) Filed: Jun. 5, 2013

Related U.S. Application Data
(60) Provisional application No. 61/655,680, filed on Jun. 5, 2012.

(51) Int. Cl. G06Q 10/06; G06Q 30/00; G06Q 50/22

(52) U.S. Cl. CPC G06Q 10/063114; G06Q 50/22; G06Q 30/018
USPC 705/2

(57) ABSTRACT

Methods and apparatus for coordinating patient care among members of a patient care team including a care provider and a patient are described. One embodiment includes receiving, from a first user, via a user interface, a selection of a care transition specified in a health act grammar and binding the first user to a source actor node associated with the selected care transition in the health act grammar. The method further includes identifying, using at least one processor, at least one target actor with the selected care transition based, at least in part, on a target actor role specified in the health act grammar, and notifying the at least one target actor of a patient care responsibility associated with the selected care transition.

### RELATED APPLICATIONS

This application claims priority under 35 U.S.C. §119(e) to U.S. Provisional Application Ser. No. 61/655,680, filed Jun. 5, 2012, which is incorporated by reference in its entirety.

### BACKGROUND

Healthcare can be viewed as a collection of millions of teams, caring for millions of patients, with limited infrastructure or incentive to support collaboration or communication between team members. It is estimated that in 2011, the failures of care coordination cost the U.S. Health Care System between $25-$45 billion. On average, caregivers spend $300/month providing care to an elderly parent or family member, which does not include the cost of the time spent caring for or coordinating that care. One of the most difficult, time consuming, and frustrating tasks for a caregiver is trying to parse what has and hasn't been done by and communicated across the care team.

Many caregivers primarily use phones and paper to communicate with care team members, with the use of electronic communication (e.g., email) being less prevalent. A variety of technologies have been developed recently to improve various aspects of the healthcare system, though none focus specifically on improving communication or care coordination between members of a care team. For example, electronic health records (EHRs) focus primarily on documentation and results reporting. Diverse products and approaches produced by the large number of EHR vendors present challenges to effective communication between team members. Regional Health Information Exchanges (HIEs) tend to be focused on data exchange, rather than care coordination or communication. Additionally, messaging systems designed to provide secure messaging for use by providers or to facilitate patient-to-provider communications typically focus on individual communications between entities rather than overall care management, analysis, and tracking.

### SUMMARY

Some embodiments are directed to a computer-implemented method for coordinating patient care among members of a patient care team including a care provider and a patient. The method comprises receiving from a first user, via a user interface, a selection of a care transition specified in a health act grammar, associating, using at least one processor, at least one target actor with the selected care transition, wherein the associating is based, at least in part, on a target actor role specified in the selected health act grammar, and providing a communication to the associated at least one target actor, wherein the communication notifies the at least one target actor of a patient care responsibility associated with the selected care transition.

Other embodiments are directed to a computer system. The computer system includes at least one storage device configured to store a plurality of health act grammars, wherein each of the plurality of health act grammars specifies at least one transition between a source actor and a target actor in providing care to a patient. The computer system further includes at least one processor programmed to provide a user interface to a plurality of members of a patient care team including a care provider and a patient, wherein the user interface is configured to display a plurality of health act grammars, receive from a first user, via the user interface, a selection of a care transition specified in one of the plurality of health act grammars, associate at least one target actor with the selected care transition, wherein the associating is based, at least in part, on a target actor role specified in the selected health act grammar; and provide a communication to the associated at least one target actor, wherein the communication notifies the at least one target actor of a patient care responsibility associated with the selected care transition.

Other embodiments are directed to a non-transitory computer-readable storage medium encoded with a plurality of computer-executable instructions that, when executed by a computer performs a method. The method comprises receiving from a first user, via a user interface, a selection of a care transition specified in a health act grammar, associating, using at least one processor, at least one target actor with the selected care transition, wherein the associating is based, at least in part, on a target actor role specified in the selected health act grammar, and providing a communication to the associated at least one target actor, wherein the communication notifies the at least one target actor of a patient care responsibility associated with the selected care transition.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a health act transactions and analysis system in accordance with some embodiments;

FIG. 2 shows a high-level view of the interactions of components in a health act transactions and analysis system in accordance with some embodiments;

FIG. 3 schematically shows components of an illustrative health act transactions grammar in accordance with some embodiments;

FIG. 4 illustrates a process for traversing a health act grammar in accordance with some embodiments;

FIG. 5 illustrates a process for interacting with a user interface in accordance with some embodiments;

FIG. 6 is a diagram of an exemplary browse view for active grammars in a health act transactions and analysis system in accordance with some embodiments;

FIG. 7 schematically illustrates a design of an actors database in accordance with some embodiments;

FIG. 8 illustrates a plurality of interactions between components of a health act transactions and analysis system in accordance with some embodiments;

FIG. 9 shows a process for sending communications using a communications module of a health act transactions and analysis system in accordance with some embodiments; and

FIG. 10 is a high-level block diagram of a computer system in which a health act transactions and analysis system in accordance with some embodiments may be implemented.

### DETAILED DESCRIPTION

The inventors have recognized and appreciated that care coordination and communication between members of a healthcare team may be improved though the use of a user interface that enables members of a healthcare team to perform care coordination activities in accordance with their roles as members of the care team. As discussed above, healthcare teams are often ad hoc groups that are assembled, at least in part, by patients who do not have knowledge of whether the team members have previously worked together or will ever work together in the future. As a result, many interactions between team members are haphazard and happenstance, and there is tremendous information loss even when communication does occur. For example, most data and knowledge is stored locally by individual caregivers making it difficult to evaluate data or metrics to understand how one healthcare team compares to other teams, both within and across organizations. To this end, some embodiments are directed to methods and apparatus for improving care coordination and tracking though a common computing environment in which members of a care team participate.

As discussed above, coordination of care responsibility between care team members is typically unstructured in a way that there exist many possible pathways through a care event such as a hospital discharge or medication reconciliation. Because of this level of variability, improvements in care coordination have been difficult. Some embodiments are directed to providing a set of structured health act grammars that specify interactions between care team members to facilitate effective communication and coordination in providing care to a patient. As used herein, the term “health act grammar” refers to a data construct that describes a structured series of health acts as patient care responsibility passes from one member of a care team (i.e., a source actor) to another member of the care team (i.e., a target actor). Health act grammars are discussed below as including actor nodes connected by care transitions that describe actions associated with a handoff between a source actor and a target actor. However, it should be appreciated that a computer system used in accordance with various embodiments may implement health act grammars in any suitable way that links actors in a care team based on a handoff of at least a portion of care responsibilities for a patient during a clinical care episode. For example, health act grammars may be implemented using tuples in a relational database system to link actors, transitions, and any other suitable information.

By defining care responsibility handoffs between different actors of a care team, the efficiency of patient care coordination may be quantified and compared across different care teams to identify which clinical care episodes are well managed, are complete, or are held up and/or problematic. In accordance with some embodiments described herein, introducing structure to describe responsibility relationships between actors in the care coordination process and coupling this structure to the healthcare delivery system enables coordination and monitoring of healthcare coordination and may provide a foundation for analyzing and rewarding best practices.

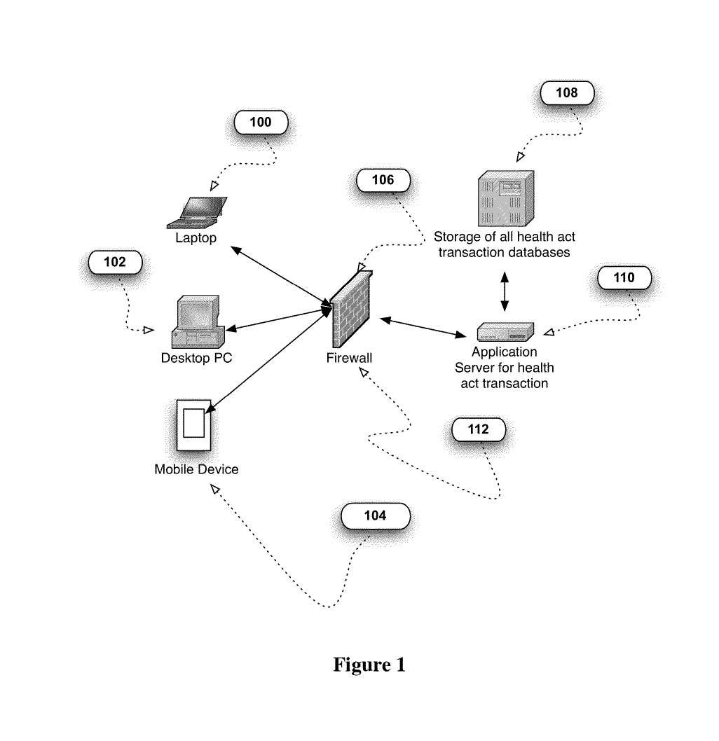

FIG. 1 illustrates a computing environment within which some embodiments may be implemented. The illustrative computing environment of FIG. 1 includes application server 110 configured to provide functionality (e.g., user interfaces) for use with one or more web-enabled platforms (e.g., laptop computer 100, desktop PC 102, mobile device such as mobile phone 104). The illustrative computing environment also includes database server 108 configured to store information including, but not limited to, application metadata such as a health act transactions grammars database described in more detail below. Database server 108 may also include identity management components for various members (also called “actors” herein) in a healthcare team including patients, care providers, payers (e.g., insurance companies), healthcare organizations (e.g., hospitals), or any other entity associated with patient care. In the illustrative computing environment of FIG. 1, both application server 110 and database server 108 reside behind a secure network firewall 106. However, it should be appreciated that the components of a computing environment for use with embodiments may be arranged in any suitable way using any suitable hardware configuration.

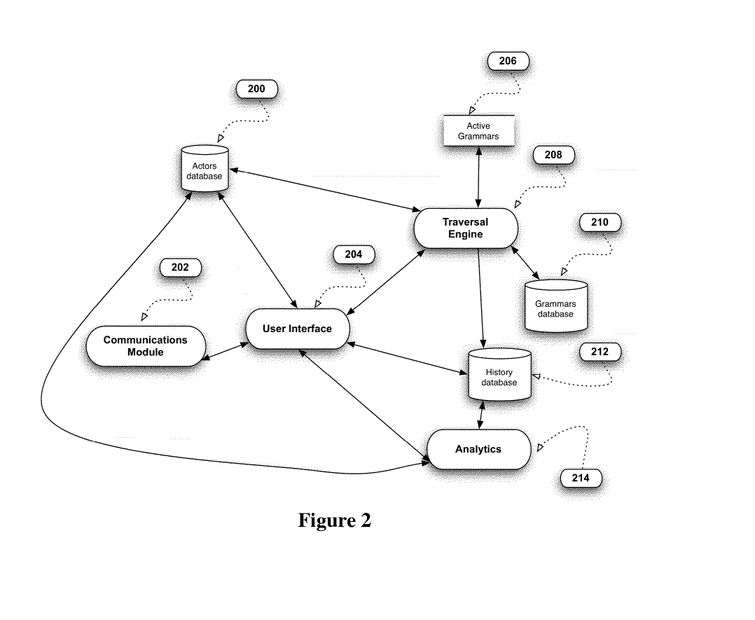

FIG. 2 illustrates a plurality of components of a health act transactions execution and analysis system in accordance with some embodiments. The components include an actors database 200, which describes potential roles on a caregiver team that individuals and organizations may be associated with. In some embodiments, actors database 200 may also include information that links caregiver team roles to real world credentials and identifiers of an individual or organization. This information may then be associated with instances of these roles for a particular health act grammar, as discussed in more detail below.

The illustrative health act transactions execution and analysis system of FIG. 2 also includes user interface 204, which may be displayed on a client device (e.g., a laptop computer, a smartphone, a tablet computer) to enable participants in the health act transactions and analysis system to interact with the system. In some embodiments, the user interface may also enable users to initiate the processing of an active health act grammar or to initiate a new health act grammar, as discussed in more detail below. Any suitable operations may be made available to a user through the user interface including, but not limited to, enabling users to select grammars, actor nodes, transitions, and payloads, as discussed in more detail below.

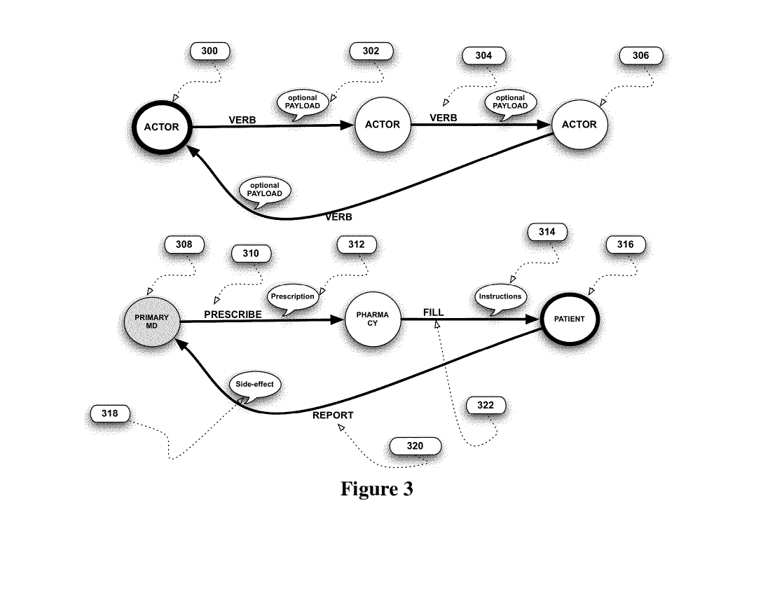

Also included in the illustrative system of FIG. 2 is grammars database 210, which includes a plurality of health act grammars (see FIG. 3) that describe recognized and allowed coordinated healthcare activities for a particular condition or circumstance. The health act grammars may be defined in any suitable way, as embodiments are not limited in this respect. For example, one or more qualified healthcare professionals (e.g., nurses, doctors) may define the components of a health act grammar for a particular condition (e.g., hospital discharge for cardiac event) and the health act grammars stored by the system may be refined over time as procedures change. Additionally, at least some of the health act grammars stored in grammars database 210 may be configurable by one or more users of the system (e.g., via the user interface) and embodiments are not limited by the extent to which the health act grammars are configurable.

As discussed in more detail below, one or more health act grammars stored in grammars database 210 may be “activated” by a user of the system. As used herein, the term “activated grammar” refers to a grammar that has been initiated by a user, but has not yet been terminated. Accordingly, activated grammars include at least one transition that has yet to be acted upon by a user of the system. In some embodiments, when a user selects a grammar for initiation (e.g., via the user interface), the grammar is added to a set of active health act grammars 206 maintained by the system. Designating a grammar as an active grammar by adding the grammar to the set of active grammars may be performed in any suitable way. For example, when a health act grammar stored in grammars database 210 is initiated, the grammar be associated with a tag that indicates the active status of the grammar. Alternatively, an indication of an active health act grammar may be added to a separate data structure that describes the set of some or all of the active grammars in the system. In some embodiments, after an active health act grammars has been completed or terminated, the grammar may be removed from the set of active health act grammars 206, as discussed in more detail below.

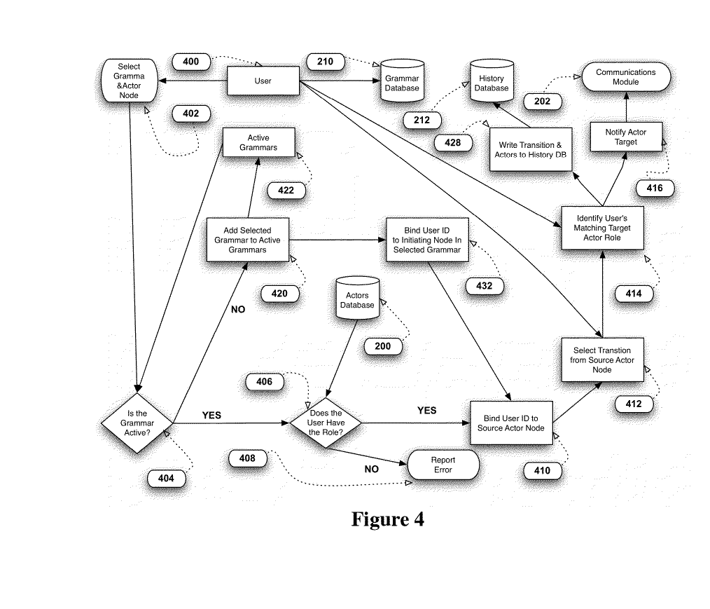

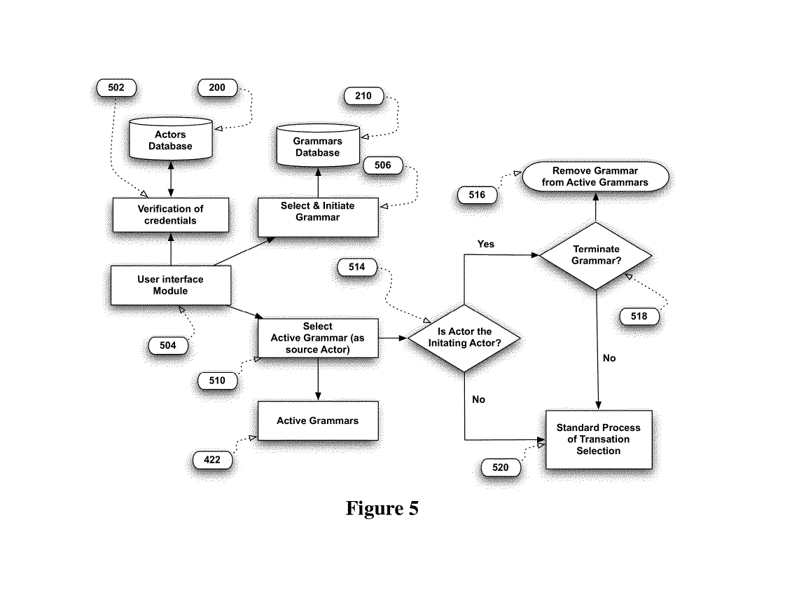

The illustrative system of FIG. 2 further includes a traversal engine 208 configured to process health act transactions represented in a health act grammar as a particular care coordination pathway defined by the grammar is followed by actors in a care team (see FIG. 4 and FIG. 5). Traversal engine 208 may be implemented using one or more processors configured to process health act grammars in any suitable way, as embodiments are not limited by the particular implementation of traversal engine 208.

In some embodiments, traversal engine 208 may also be communicatively coupled to health act history database 212 to store therein, information about the completion of one or more transitions in a health act grammar. The information stored in health act history database 212 may include, but is not limited to, timing, annotation, and authorship information for health act transactions that have been processed by traversal engine 208. The information stored by health act history database 212 may be used in any suitable way, as embodiments are not limited in this respect. For example, the information may be used to evaluate a level of coordination of team members in completing the transactions in a health act grammar both within and across organizations.

Analytics component 214 may be configured to use information stored in the health act history database 212 to generate one or more reports and/or metrics of performance for profiling aspects of the conduct of coordinated care as determined by the health act grammars. Analytics component 214 may be configured to process information stored in health act transactions database to determine any suitable metric for evaluating care coordination in accordance with various embodiments. Additionally, care coordination may be evaluated for particular individuals, particular organizations, or across organizations, as embodiments are not limited in this respect. Analytics related to the network of connections embodied in the team may also be used by analytics component 214 to provide information providers and organizations related to patterns of referrals. The network of connections into and out of organizations may also be aggregated by analytics component 214 to provide organizations information about patient referrals outside of their network. Analytics component 214 may provide the analytics to a user in any suitable way. In some embodiments, the one or more analytics may be provided in the form of a dashboard accessible by individual providers and organizations. A correlation engine may be provided, which will allow patient outcome data to be incorporated into the analytic processing. In some embodiments, results of this processing may be in aggregate form only with no patient specific identifiers made available in the reports.

Communications component 202 may be configured to transmit one or more messages to users associated with the system. In some embodiments, traversal engine 208, analytics component 214, or some other component of the system may instruct communications component 202 to transmit the one or more messages to a user via the user interface 204. In some embodiments, users of the health act transactions and analysis system may also send messages for distribution via the communications component. Messages sent via communications component 202 may be sent using any suitable communications medium, as embodiments are not limited in this respect.

As described above, a health act grammar used in accordance with some embodiments includes a set of care transitions from a first actor (also called a “source actor” herein) of a care team to a second actor (also called a “target actor” herein) of the care team. The care transitions represent the transfer of part or all of the responsibility for patient care from the source actor to the target actor. As shown in the illustrative health act grammar of FIG. 3, the transfer of responsibility may be defined by a verb 304 that annotates or tags the care transition. Any suitable verbs that described archetypal medical activities, (e.g., PRESCRIBE 310, FILL 322, REFER, DIAGNOSE, TREAT, REPORT 320) may be used for annotating care transitions, and embodiments are not limited by the particular set of verbs used. For example, in some embodiments, verbs used to annotate care transitions are drawn from a limited controlled vocabulary defined in any suitable way.

Some care transitions in accordance with embodiments may be associated with an informational payload 302. For example, the payload may include information that is not processed directly by a health act transactions and analysis system in accordance with some embodiments, but the information in the payload may include human-readable content or codified content that can be interpreted by an external system in communication with the health act transactions and analysis system. Examples of payloads include, but are not limited to, prescription data 312, instructions for patients 314, and reports of side effects 318 of a medication.

The information in the payload may be transmitted to an external system for processing. For example, prescription data 312 may be automatically forwarded to an electronic prescribing system for processing by the prescribing system. The type or amount of information included in a payload associated with a care transition in accordance with embodiments is not limited in any way, as any suitable information may be used. Additionally, any number of care transitions (including no care transitions) in a health act grammar may be associated with a payload, as embodiments are not limited by the number of transitions in a health act grammar that are associated with a payload.

The illustrative health act grammar in FIG. 3 is represented graphically with circles denoting the roles of the actors 306 and an arrow representing the care transition between the actors involved in the transition. The arrow for each care transition is labeled with a verb 304 that describes the transition, with the arrow extending from a source actor to a target actor who is the target of the care transition. A thicker-lined circle denotes the source actor 300 who is an actor that initiates the health act grammar. As shown in the lower part of FIG. 3, actor 308 is the initiating actor for the illustrate health act grammar. Actor 308 is also the source actor associated with the first care transition in the health act grammar labeled “PRESCRIBE.”

In accordance with some embodiments, health act grammars each include an initiating actor node 300, which defines the type or types of actors authorized to initiate the grammar. For example, continuing with the example of FIG. 3, only certain types of actors (e.g., physicians) may be authorized to initiate a health act grammar that relates to prescribing medication. By restricting the types of actors that can initiate particular grammars by their roles, it can be assured that only team members authorized to perform or initiate particular actions become initiating actors for those actions. Exemplary processes for authorizing an actor based on the actor's assigned role(s) are described in more detail below.

In some embodiments, health act grammars may include a path that returns to the initiating actor node to ensure that there is at least one opportunity for the initiating actor to determine what happened as a result of the act of healthcare coordination that the initiating actor initiated in selecting a specific grammar. For example, the care transition “REPORT” in the illustrative health act grammar of FIG. 3 is associated with a target actor who is the primary physician that initiated the health act grammar.

Although the exemplary health act grammar shown in FIG. 3 is illustrated using a graphical representation, it should be appreciated that a health act grammar used in accordance with embodiments may alternatively be represented in any other suitable way. For example, in some embodiments the grammar is represented for computation as a relational database, which connects tuples of grammar identity to a source actor and target actor (or class of target actors), a verb describing the transition, and optionally, a payload.

A canonical notation for this tuple is:

### <Grammar ID> <Source Actor ID> <Target Actor ID> <Verb ID> <Payload>

where the identifiers (IDs) refer to codes in a data dictionary. An alternative computational embodiment of the health act grammar is as a Resource Description Framework (RDF) tuple, which is a graph-based model for describing Internet resources (e.g., web pages, email messages) and how these resources relate to each other. It should be appreciated, however, that any suitable computational representation may be used in accordance with various embodiments.

As discussed above, health act grammars used in accordance with some embodiments may be authored by any suitable entity including, but not limited to, clinicians, payers, patient advocates, or other authorized entities. Collectively the health act grammars for each implementation represent the entirety of allowable health care acts of interest for the coordination of care in that implementation and of interest for the analysis and monitoring of coordinated care for the implementation.

FIG. 4 illustrates a process for traversing care transitions of a health act grammar in accordance with some embodiments. In act 402, a health act grammar is selected by a user. For example, a set of grammars available to a particular user may be displayed on a user interface and the user may interact with the user interface to select a particular grammar. As discussed above, in some embodiments users depending, at least in part, on the roles assigned to them, may be provided with different levels of access to select particular grammars stored by the system. That is, classes of users may be authorized to initiate some grammars, but not others. For example, the class of physicians may be authorized to initiate a health act grammar for hospital discharge, whereas the class of users who are patients may not be authorized to initiate such a grammar. Additionally, although a user may not be authorized to initiate a health act grammar, the user may nonetheless participate as an actor in the grammar once activate when the user is identified as a target actor associated with a care transition, as discussed in more detail below.

When a user accesses the user interface, it may be determined which grammars are accessible to the user (e.g., which grammars the user is authorized to initiate) and only accessible grammars may be made available for selection by the user. In other embodiments, all grammars available in a grammar database may be made available for selection by a user, and in response to selection of a grammar, it may be determined whether the user has proper credentials to access the grammar. The determination of which grammars are accessible to a user may be made in any suitable way, and embodiments are not limited in this respect.

The process then proceeds to act 404 where it is determined whether the selected health act grammar is currently active. If it is determined that the selected grammar is not currently active, the process proceeds to act 420 where the selected grammar is “initiated,” for example, by adding the selected grammar to a set of active grammars 422 maintained by the system, as discussed above. Active grammars 422 include all grammars that have been initiated through selection by a user, but have not yet been completed or terminated.

After the grammar has been added to the set of active grammars, the process proceeds to act 432 where the user 400 who selected the grammar is associated with the initiating node of the activated grammar. That is, the actor node for the selected health act grammar is designated as the initiating actor of that grammar instance. In some embodiments, the assignment of an initiating actor to a health act grammar is a permanent assignment for as long as the grammar is active.

Associating a user with a selected actor node in a health act grammar (also called “binding” a user to an actor node herein) may be performed in any suitable way, as embodiments are not limited in this respect. For example, in some embodiments, binding of a user to a selected actor role in an active grammar, regardless of whether the actor was the one who initiated that grammar, may be accomplished in act 406 by performing a lookup in the actor database 200 to determine whether the user is present in that database with that role. In some embodiments, each user may be associated with one or more roles and these associations may be reflected in one or more entries in the actor database 200. In such embodiments, a lookup may be performed by sending a query to the actor database 200 to identify particular roles associated with the currently logged in user, or a lookup may be performed in any other suitable way.

If it is determined in act 406 that the user is not associated with an appropriate role for a particular actor node in the activated grammar, the process proceeds to act 408, where an error is reported. If it is determined that the user is associated with an appropriate role for the particular actor node, the process proceeds to act 410 where the user is associated with the source actor node for the activated health act grammar. The process then proceeds to act 412, where a selection of a care transition in the activated health act grammar is received, with the user making the selection having been assigned to the source actor role of the care transition. The process then proceeds to act 414 where the selected care transition is traversed thereby identifying the target actor role associated with the care transition.

Entities associated with the care team and having the identified role for the target actor are then identified. For example, one or more actual entities that may fill the target actor role associated with the selected transition may be identified using, at least in part, information from the actors database 200, as described in more detail below.

In some embodiments, when user 400 selects a care transition (e.g., from those available from that actor node on the selected grammar 402), the traversal engine marks the selected transition as traversed, selects the node pointed to by the transition as the target actor node, and performs a lookup from the actors database 200 to determine the individual(s)/organization(s) available who match the role described by that target actor node. After identifying the appropriate actors who may fill the target actor role in a transition, a listing of appropriate actors may be provided via the user interface for selection by the user. Alternatively, an actor or actors to fill the target actor role may be selected in any other suitable way. For example, in some embodiments, one or more target actors may be automatically selected without user input. Automatic selection of target actor(s) to associate with a care transition may be performed in any suitable way, as embodiments are not limited in this respect.

The process then proceeds to act 416 where one or more of the target actors is notified that they are expected to be responsible for some patient care in the manner described by the selected transition. The notification sent to the target actor(s) may be manually or automatically generated after the one or more target actors have been identified. Each care transition in a health act grammar is characterized by a verb that describes the action to be performed. In some embodiments, the notification may be based, at least in part, on information associated with the transition including, but not limited to, the verb annotating the care transition.

Upon receiving the notification, the target actor(s) can then take one or more appropriate actions. After completing the appropriate action(s), the target actor may then have the option to select another care transition within the same (or different) grammar. In response to selecting a new care transition in the health act grammar, the target actor for the just completed transition becomes the source actor on the newly-selected transition, and the process described above for identifying target actors is repeated.

In some embodiments, active grammars may only be completed or terminated by the initiating actor of the health act grammar. As discussed above, in some embodiments, an initiating actor may be requested to terminate a grammar when a transition in the grammar points to the initiating actor as the target actor (e.g., the transition labeled REPORT 320 in FIG. 3). The request to terminate a grammar may be made in any way including, but not limited to, displaying the request on the user interface. In some embodiments, the initiating actor may terminate the specified grammar prior to receiving a request to do so.

In addition to maintaining a set of active grammars, in some embodiments, the state of each of the active grammars is tracked to enable a user to identify which grammars have been initiated but not completed. In some embodiments, users may be able to interact with the user interface to determine which actions have yet to be performed to complete one or more active grammars. For example, a patient or some other member of a care team may be able to identify incomplete actions and associated target actors that have been assigned to perform those actions. Providing such transparency to patients (or other users) may enable the patient to take a more active role in their care and improve the efficiency by which patient care is coordinated.

As discussed above, a deficiency with conventional healthcare systems is the inability to track and assess care coordination within a care team over time, across care teams within an organization, and across organizations. In some embodiments, information associated with operations of the traversal engine are stored in act 428 to facilitate tracking and evaluation of care coordination activities associated with health act grammars. Any suitable information may be stored in health act history database 212 including, but not limited to, the actor that selected the grammar, the transitions selected, the messages sent to the communications module, and date/time stamps for each performed operation. The stored information may then be analyzed by a health act analytics module to evaluate one or more metrics for assessing patient care coordination.

A brief example enabled by a health act transactions and analysis system in accordance with some embodiments is now provided: After a patient has completed an inpatient visit for heart failure at a local hospital, the patient's cardiac specialist is about to discharge the patient. Prior to discharging the patient, the cardiac specialist accesses her mobile phone and using the mobile phone's web browser user interface, selects the health act grammar for discharge of heart failure patients. She selects the REPORT care transition in that grammar with the primary (referring) MD as the target actor. She also selects the PRESCRIBE care transition with the local pharmacy as the target actor. The cardiac specialist wants to include prescription details for the pharmacy as a payload for the PRESCRIBE care transition. By selecting the PRESCRIBE transition, a health act transactions and analysis system that has an authorized network connection to an electronic prescribing system may simultaneously trigger the issuance of the prescription, filled with the prescription details from the PRESCRIBE transition payload, to the external pharmacy system.

After the local pharmacy and the primary MD have selected the ACKNOWLEDGE care transition, which points back to the cardiac specialist as a target node, the cardiac specialist, as the initiating actor, may terminate the grammar knowing that the pharmacy and primary doctor are now ready for the patient's discharge. Later that month, this health act transaction may be listed as one of the top 10 most rapid discharge actions to be completed in the metropolitan area and the three actors involved (cardiac specialist, primary MD, specific pharmacy) may have their individual and team statistics updated accordingly.

The user interface may be implemented in any suitable way, and embodiments are not limited in this respect. For example, the user interface may be implemented as HyperText Markup Language 5 (HTML5) front end to a server that provides authentication and then pass-through of interactions that are driven by the grammar traversal engine. Alternatively, the user interface may be implemented as an Apple iPhone Operating System (iOS) application also serving as a front end to the server, or using any other suitable technique.

FIG. 5 illustrates a process for interacting with a user interface to process a health act grammar in accordance with some embodiments. In act 504, a user logs into the system via a user interface module and provides authentication information (e.g., username, password). The process proceeds to act 502 where the user's authentication information is verified against credentials stored in the actors database 200.

After it has been verified that the user is authorized to use the system, the user may select a health act grammar from grammar database 210 to initiate it (act 506) or select a health act grammar that is already active (act 510) by selecting the grammar from a set of active grammars 422. When the user in act 510 decides to select an active grammar, the active grammar may either be an active grammar in which the user is a target actor pointed to by a care transition previously selected by another actor or an active grammar which the user had previously initiated. After selecting an active grammar, the process proceeds to act 514, where it is determined whether the user was the initiating actor for the selected grammar. If it is determined that the user was the initiating actor, the process proceeds to act 518 where it is determined whether the user wants to terminate the selected grammar. If it is determined that the user wants to terminate the selected grammar, the process proceeds to act 516, where the selected grammar is removed from the set of active grammars. If it is determined in act 518 that the user does not want to terminate the selected grammar, or if it is determined in act 514 that the user is not the initiating actor, the process proceeds to act 520, where a care transition permitted by the selected grammar may be selected by the user, as discussed in further detail below.

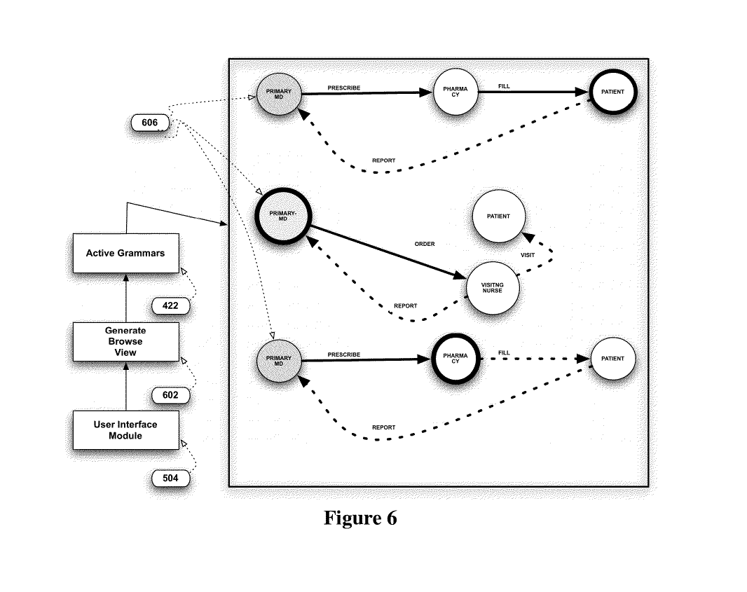

As shown in FIG. 6, in some embodiments, the user interface module 504 also provides a browse view 602 of the active grammars 422. Any suitable information may be provided to a user in the browse view, and different ways of sorting the grammars may be presented (for example, by set or date) and the browse view shown in FIG. 6 is merely one example of information that may be provided. Additionally, different users may be provided different levels of access to browse active grammars. For example, the user class of patients may only browse grammars that relate to their particular care, the user class of physicians may browse grammars for which they were an actor, the user class of hospital administrators may browse grammars for which their hospital or a caregivers at their hospital was involved as an actor, and the class of system administrators may browse all grammars stored by the system. Other permissions for viewing grammars in browse view are also possible, and embodiments are not limited in this respect.

In the illustrative browse view of FIG. 6, the browse view shows the path followed in each grammar 606 for which the user was one of the actors. The browse view may show which actor nodes in each active grammar have been bound to actual users, which transitions were followed, which was the initiating actor and node, which transitions have not been traversed (dotted line), and the current source actor (thick outlined node). In some embodiments, the user interface may also provide other browse functions (e.g., a list-view browse function (not shown)) of the health act history database.

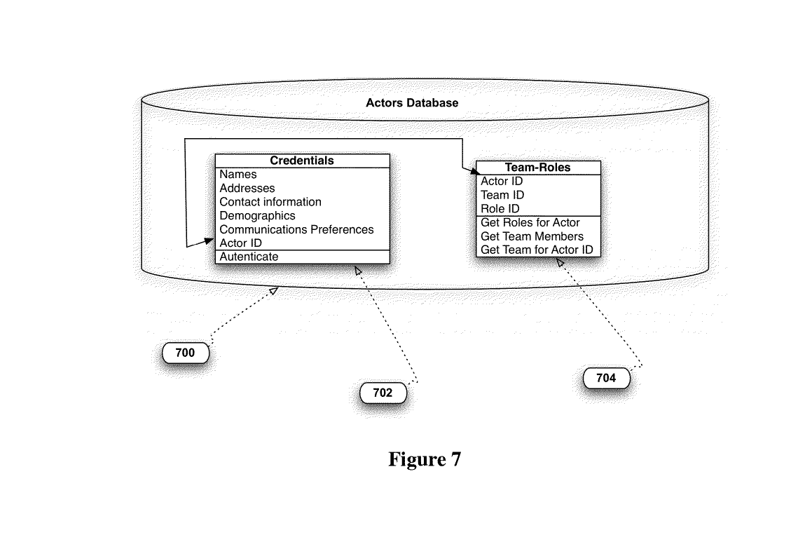

FIG. 7 shows an illustrative actors database 700 implemented as two principal data structures in a database, though it should be appreciated that the information in actors database 700 may be stored and/or structured in any suitable way, and embodiments are not limited in this respect. The first data structure is a repository of “real-world credentials” 702 that includes such items as first and last name, date of birth, address, telephone number, preferred communication contact method, email, and username. The first data structure may be implemented using any of a variety of standard industry embodiments such as a Lightweight Directory Access Protocol (LDAP) server or open standard for Authorization (oAuth) server (e.g. OpenOTP). In addition to including user credentials, the first data structure also includes a unique Actor ID data type. In the illustrative implementation of FIG. 7, the unique Actor ID serves as the primary key to look up the various roles of that actor in the Team-Roles data structure 704, described in more detail below.

The Team-Roles data structure 704 enumerates permitted actor roles for each actor (denoted by Actor ID) within the health act transactions and analysis system in accordance with some embodiments. For example, permitted actor roles may include, but are not limited to, PRIMARY MD, PHARMACY, NURSE PRACTITIONER, and PATIENT. Each of the roles may be represented by a ROLE ID number. The TEAM-ROLE data structure also includes a TEAM ID, which allows the delineation of (potentially overlapping) groups of actors. This allows an actor to have different roles in different teams. Team groupings may be used in any suitable way by any of the components of the health act transactions system including, but not limited to, use by the health act analytics module to define team-based metrics of coordination of care performance and the communication module to allow broadcast messages to team members.

In the illustrative implementation of FIG. 7, the TEAM-ROLE data may be represented by the following tuple:

### <Actor ID> <Role ID> <Team ID>

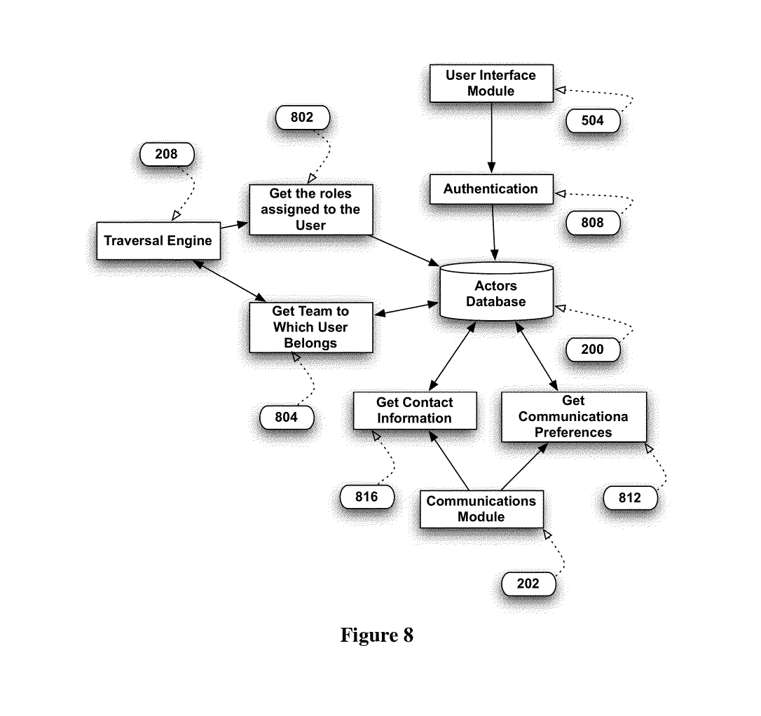

FIG. 8 illustrates various interactions between components of a health act transactions system with actors database 200 in accordance with some embodiments. As shown in FIG. 8, the actors database 200 may be accessed by the user interface module 504 to authenticate 808 users, as described above. Additionally, the team attribute 804 may be accessed from the actors database 806 by the user interface module 504 to identify the care team members so a user can select one or more team members as target(s) actors of a care transition in a health act grammar. The actors database 200 may also be accessed by the traversal engine 208 to determine which roles a particular user has been assigned 802. The actors database may also be accessed by the communications module 202 to determine a preferred communication method 812 for each user, the user's email and telephone number, the members of the team(s) to which the user belongs and other contact information 816 stored in the actors database 200.

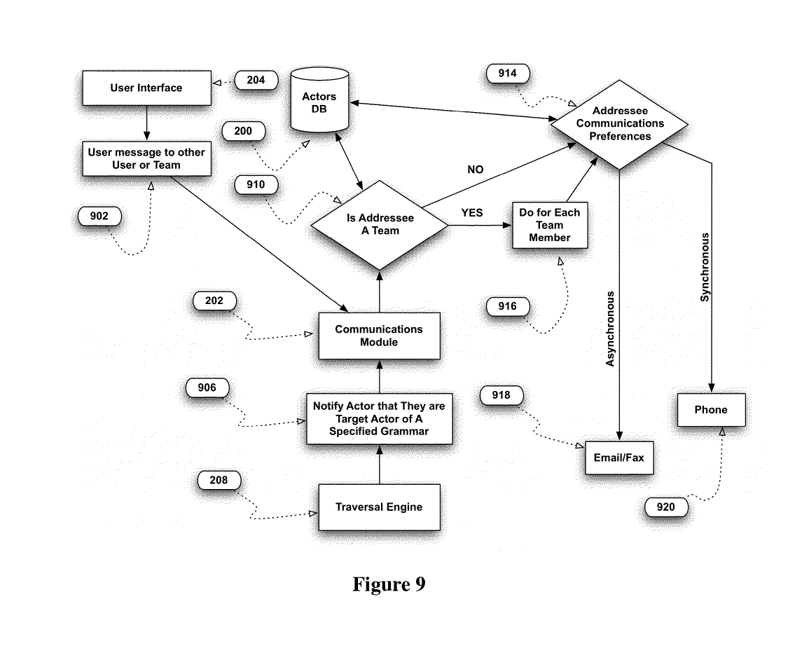

FIG. 9 illustrates an exemplary process for transmitting messages using communications module 202. As shown in FIG. 9, the communication module 202 may select a communications modality for each specific message forwarded to communications module 202 from other modules of the health act transactions and analysis system (e.g., the user interface 204 or the traversal engine 908). In some embodiments, the selection of a communication modality 914 to use may be determined based, at least in part, on whether that specific message is tagged as “synchronous” (e.g., telephone 920) or “asynchronous” (e.g., electronic mail or facsimile 918). Communication preferences may be among the default preferences selectable for each actor from the actors database 200, as described above (and further illustrated in FIG. 8).

The communications module may interpret the tags associated with messages and the user preferences to determine how to send the message to the recipient user. For example, if a message is tagged as asynchronous, it may be sent to the recipient by an asynchronous mechanism (e.g. email, fax 918) unless the preferred communication method of the recipient is synchronous (e.g. telephone call 920).

In some embodiments, if the message is tagged as real-time, the message may always be sent by synchronous methods irrespective of the recipient's preferred communication method, thereby overriding the actor's preference. If the recipient is not a single actor but a specified team 910, the message may be sent to all members of the team if certain conditions apply (e.g., if the sender is a member of that specified team 916).

In some embodiments, the user interface 204 enables any actor to send a message to another actor 902 via the communications module 202 at any time. As discussed above, messages may be automatically sent from the traversal engine 208 via the communications module 202 when a transition from one actor (originally the source actor) to another actor (the target actor of the transition) as defined by a specified active grammar 906 is triggered. Such notifications inform the target actor that they are expected to take responsibility for the continued execution of that particular health act transaction grammar.

In embodiments where the health act history database is automatically populated by the traversal engine (as illustrated in FIG. 4), the health act history database provides a complete record of the coordination of care across a care team for each transition across each grammar selected through the user interface module. That is, the health act history database includes information about which actor selected which grammar, the transition selected, the messages sent to the communications module along with real-time time stamps of all these records.

In embodiments that employ a relational database implementation, an illustrative relational database data structure for the health act history database may be a single table with a tuple described as follows:

### <Grammar ID> <Source Actor ID> <Target Actor ID> <Verb ID> <Payload> <Message>

### <Date-Time-Open-Transaction> <Date-Time-Dispatch-Transaction>

where Grammar ID specifies which of the grammars were used, the Actor IDs specify the source and target actor, the Verb ID specifies which transition in the specified grammar was selected. The optional payload attribute specifies content that is human or machine readable but that is not processed by the health act transactions and analysis system—i.e. it is for use by systems external to the system, as described above. The optional message attributes specify a message that will be forwarded to the communications module to send to the target actor. The Date-Time-Open-Transaction denotes the time the user started to specify a transaction and Date-Time-Dispatch-Transaction denotes the time the user completed the transaction. Other alternative computational implementations (e.g., a collection of RDF tuples) may also be used.

As discussed briefly above, an analytics module may use information stored in the health act history database along with any other suitable information to evaluate one or more metrics to assess care coordination, quality metrics, patient outcomes, or any other healthcare parameter of interest. For example, the analytics module may be configured to evaluate surveys conducted using a SURVEY verb to evaluate, at least in part, a patient outcome metric. In some embodiments, the analytics module uses the data in the health act history database to conduct several classes of analyses of the performance of individual team members in the coordination process. These include, but are not limited to, per-team-member summary statistics (e.g. minimum, maximum, median, mean, interquartile distance) for i) time from receipt of a transition (i.e. the team members was a target of a transition) to the posting of a new transition, ii) time from start to completion of all grammars in which the team member participated, iii) proportion of grammars which were left incomplete when the last target actor was the specified team member, iv) time to read/acknowledge to messages from the communications module, v) the proportion of transitions triggered in the health act transactions and analysis system by the specified provider compared to patient visits to the same provider, vi) the frequency of initiation of each of the available grammar types in the grammar database.

By accessing the team ID's of each user in the actors database, individual members' performance can be aggregated over a team to provide an aggregate set of performance measures for each care team. For example, for each team, the time from receipt of a transition to the triggering of the next transition may be averaged across all members of each team. This then allows all teams to be ranked relative to each other by any of the team performance metrics of interest (e.g., to the payer or prospective patient).

In some embodiments, analytics module may be configured to evaluate one or more practice-based analytics. The practice-based analytics may help physicians and provider groups manage their practices and understand how providers and patient load move through their practice. Any suitable practice-based analytics may be evaluated including, but not limited to, analytics related to referring physicians, patient volumes, and patient load. Additionally, analytics may be used for any suitable purpose including, but not limited to, informing physician referrals based on individual and/or care team performance and determining physician ratings based on individual and/or care team performance.

In some embodiments, analytics module may be configured to evaluate an amount of time a user (e.g., a provider) has spent doing care coordination work for one or more patients. The results of this analysis may enable a practice to view their patient panel and how much time each patient and provider is spending doing care coordination work. Such information may be useful, for example, for billing and provider time studies.

In some embodiments, analytics module may be configured to determine a correspondence between individual and/or team performance and one or more healthcare events including, but not limited to, hospital admissions and emergency room (ER) visits.

Health transactions analytics may be evaluated in response to user input, periodically at regular or irregular intervals, and/or in real-time. For example, any health act transaction grammar that does not complete in two days or does not have a new transition within a day, may be compiled in a real-time report of all active grammars that bear greater attention by healthcare providers or case managers. Alternatively, for example, each provider may be ranked by their median response time to patient result inquiries or percentage of completed conversations with the primary care provider prior to discharge of a patient from the hospital.

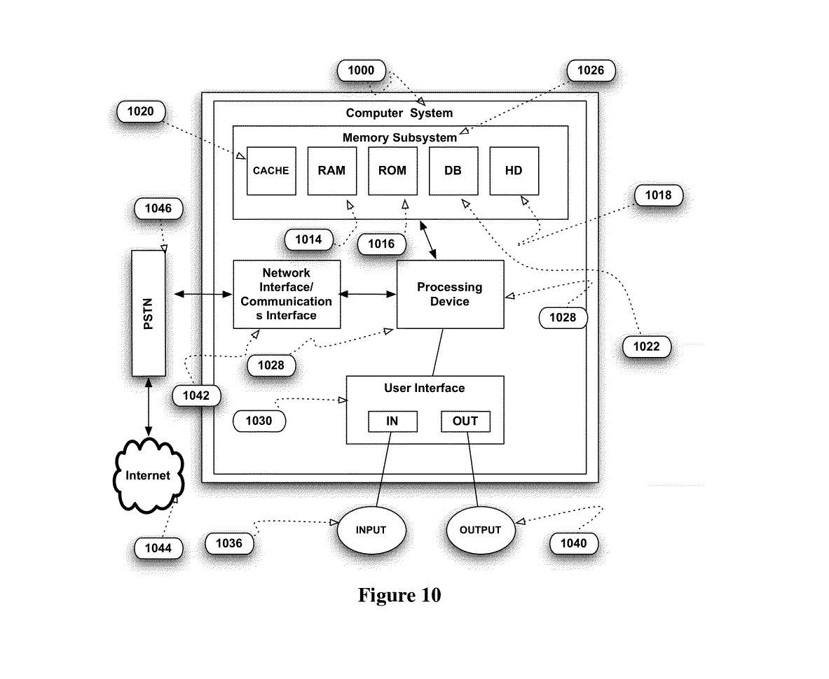

As shown by FIG. 10, a health act transactions and analysis system in accordance with some embodiments, may be implemented as a system including computer hardware components and/or as computer-implemented methods. The health act transactions and analysis system may additionally include a plurality of modules or subsystems. The modules or subsystems, such as the traversal engine module and the communications module, may be implemented in hardware, software, firmware, or any combination of hardware, software, and firmware, and may or may not reside within a single physical or logical space. For example, the modules or subsystems referred to in this document and which may or may not be shown in the drawings, may be remotely located from each other and may be coupled by a communication network.

Furthermore, FIG. 10 is a high-level hardware block diagram of a system computer 1000 that may be used to execute software or logic to implement the health act transactions and analysis system. The computer 1000 may be a personal computer and may include various hardware components, such as RAM 1014, ROM 1016, hard disk storage 1018, cache memory 1020, database storage 1022, and the like (also referred to as “memory subsystem 1026”). The computer 1000 may include any suitable processing device 1028, such as a computer, microprocessor, RISC processor (reduced instruction set computer), CISC processor (complex instruction set computer), mainframe computer, work station, single-chip computer, distributed processor, server, controller, micro-controller, discrete logic computer, smartphone or mobile device or devices and the like, as is known in the art. For example, the processing device 1028 may be an Intel Pentium® microprocessor, x86 compatible microprocessor, or equivalent device, and may be incorporated into a server, a personal computer, or any suitable computing platform.

The memory subsystem 1026 may include any suitable storage components, such as RAM, EPROM (electrically programmable ROM), flash memory, dynamic memory, static memory, FIFO (first-in, first-out) memory, LIFO (last-in, first-out) memory, circular memory, semiconductor memory, bubble memory, buffer memory, disk memory, optical memory, cache memory, and the like. Any suitable form of memory may be used, whether fixed storage on a magnetic medium, storage in a semiconductor device, or remote storage accessible through a communication link. A user or system interface 1030 may be coupled to the computer 1000 and may include various input devices 1036, such as switches selectable by the system manager and/or a keyboard. The user interface also may include suitable output devices 1040, such as an LCD display, a CRT, various LED indicators, a printer, and/or a speech output device, as is known in the art.

To facilitate communication between the computer 1000 and external sources, a communication interface 1042 may be operatively coupled to the computer system. The communication interface 1042 may be, for example, a local area network, such as an Ethernet network, intranet, Internet, or other suitable network 1044. The communication interface 1042 may also be connected to a public switched telephone network (PSTN) 1046 or POTS (plain old telephone system), which may facilitate communication via the Internet 1044. Any suitable commercially-available communication device or network may be used.

The logic, circuitry, and processing described above may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for examples, instructions for execution by a processor, controller, or other processing device.

The medium may be implemented as any device that contains, stores, communicates, transports executable instructions for use by or in connection with an instruction executable system, apparatus, or device. Alternatively or additionally, the logic may be implemented as analog or digital logic using hardware, such as one or more integrated circuits, or one or more processors executing instructions; or in software in an application programming interface (API) or in a Dynamic Link Library (DLL), functions available in a shared memory or defined as local or remote procedure calls; or as a combination of hardware and software.

The systems may include additional or different logic and may be implemented in many different ways. A processor may be implemented as a controller, microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instructions may be parts of a single program, separate programs, or distributed across several memories and processors.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments comprises at least one non-transitory computer-readable storage medium (e.g., a computer memory, a floppy disk, a compact disk, a tape, etc.) encoded with a computer program (i.e., a plurality of instructions), which, when executed on a processor, performs the above-discussed functions of the embodiments. The computer-readable storage medium can be transportable such that the program stored thereon can be loaded onto any computer resource to implement the aspects discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects.

Various aspects of the embodiments may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments in detail, various modifications and improvements will readily occur to those skilled in the art. Such modifications and improvements are intended to be within the spirit and scope of embodiments. Accordingly, the foregoing description is by way of example only, and is not intended as limiting. Embodiments are limited only as defined by the following claims and the equivalents thereto.

What is claimed is:

1. A computer-implemented method for coordinating patient care among members of a patient care team including a care provider and a patient, the method comprising:
receiving, from a first user, via a user interface, a selection of a care transition specified in a health act grammar;
associating, using at least one processor, at least one target actor with the selected care transition, wherein the associating is based, at least in part, on a target actor role specified in the selected health act grammar; and
notifying the at least one target actor of a patient care responsibility associated with the selected care transition.

2. The method of claim 1, further comprising:
receiving, from a second user, a selection of the health act grammar;
adding the health act grammar to a set of active grammars in response to receiving the instruction; and
designating the second user as the initiating actor for the health act grammar.

3. The method of claim 2, further comprising:
receiving an instruction from the initiating actor to terminate the health act grammar; and
removing the health act grammar from the set of active grammars after receiving the instruction to terminate the health act grammar.

4. The method of claim 3, further comprising:
determining that a target node of the selected care transition is associated with the initiating actor for the health act grammar; and
prompting the initiating actor to terminate the health act grammar after determining that the target node of the selected care transition is associated with the initiating actor for the health act grammar.

5. The method of claim 1, further comprising:
binding the first user to a source actor node of the selected care transition, wherein binding the first user to the source actor node of the selected care transition comprises:
determining a source actor role associated with the selected care transition;
querying an actors database to determine whether the first user is associated with the determined source actor role; and
binding the first user to the source actor node of the selected care transition in response to determining that the first user is associated with the determined source actor role.

6. The method of claim 1, further comprising:
determining preferred communication contact information for the identified at least one target actor; and
wherein notifying the at least one target actor comprises sending a message to the at least one target actor in accordance with the determined preferred communication contact information.

7. The method of claim 1, further comprising:
storing information related to the selected care transition after performance of at least one action by one or more of the identified at least one target actors; and
evaluating at least one metric based, at least in part, on the stored information.

8. The method of claim 1, further comprising:
associating a payload with the selected care transition, wherein the payload provides an integration point with an external information system for transactions forwarded to the external information system.

9. The method of claim 1, wherein the identified at least one target actor comprises an organization.

10. A computer system, comprising:
at least one storage device configured to store a plurality of health act grammars, wherein each of the plurality of health act grammars specifies at least one transition between a source actor and a target actor involved in the care of a patient; and
at least one processor programmed to:
provide a user interface to a plurality of members of a patient care team including a care provider and a patient, wherein the user interface is configured to display a plurality of health act grammars;
receive, from a first user, via the user interface, a selection of a care transition specified in one of the plurality of health act grammars;
associate at least one target actor with the selected care transition, wherein the associating is based, at least in part, on a target actor role specified in the selected health act grammar; and
notify the at least one target actor of a patient care responsibility associated with the selected care transition.

11. The computer system of claim 10, wherein the at least one processor is further programmed to:
receive, from a second user, a selection of the health act grammar;
add the health act grammar to a set of active grammars in response to receiving the instruction; and
designate the second user as the initiating actor for the health act grammar.

12. The computer system of claim 11, wherein the at least one processor is further programmed to:
receive an instruction from the initiating actor to terminate the health act grammar; and
remove the health act grammar from the set of active grammars after receiving the instruction to terminate the health act grammar.

13. The computer system of claim 10, wherein the at least one processor is further programmed to:
bind the first user to a source actor node of the selected care transition, wherein binding the first user to the source actor node of the selected care transition comprises:
determining a source actor role associated with the selected care transition;
querying an actors database to determine whether the first user is associated with the determined source actor role; and
binding the first user to the source actor node of the selected care transition in response to determining that the first user is associated with the determined source actor role.

14. The computer system of claim 10, wherein the at least one processor is further programmed to:
store, on the at least one storage device, information related to the selected care transition after performance of at least one action by one or more of the identified at least one target actors; and
evaluate at least one metric based, at least in part, on the stored information.

15. The computer system of claim 10, wherein the at least one processor is further programmed to:
associate a payload with the selected care transition, wherein the payload provides an integration point with an external information system for transactions forwarded to the external information system.

16. A non-transitory computer-readable storage medium encoded with a plurality of computer-executable instructions that, when executed by a computer performs a method, the method comprising:
receiving, from a first user, via a user interface, a selection of a care transition specified in a health act grammar;
associating, using at least one processor, at least one target actor with the selected care transition, wherein the associating is based, at least in part, on a target actor role specified in the selected health act grammar; and
notifying the at least one target actor of a patient care responsibility associated with the selected care transition.

17. The computer-readable storage medium of claim 16, wherein the method further comprises:
receiving, from a second user, a selection of the health act grammar;
adding the health act grammar to a set of active grammars in response to receiving the instruction; and
designating the second user as the initiating actor for the health act grammar.

18. The computer-readable storage medium of claim 16, wherein the method further comprises:
binding the first user to a source actor node of the selected care transition, wherein binding the first user to the source actor node of the selected care transition comprises:
determining a source actor role associated with the selected care transition;
querying an actors database to determine whether the first user is associated with the determined source actor role; and
binding the first user to the source actor node of the selected care transition in response to determining that the first user is associated with the determined source actor role.

19. The computer-readable storage medium of claim 16, wherein the method further comprises:
storing information related to the selected care transition after performance of at least one action by one or more of the identified at least one target actors; and
evaluating at least one metric based, at least in part, on the stored information.

20. The computer-readable storage medium of claim 16, wherein the method further comprises:
associating a payload with the selected care transition, wherein the payload provides an integration point with an external information system for transactions forwarded to the external information system.
